(19) United States
(12) Patent Application Publication
(10) Pub. No.: US 2003/0120355 A1
(43) Pub. Date: Jun. 26, 2003

(54) Biocompatible and biodegradable polymers for diagnostic and therapeutic radioisotope delivery

(76) Inventors: Urs Hafeli, Cleveland, OH (US); Sandra Rudershausen, Rostock (DE); Joachim Teller, Rostock (DE); Cordula Gruttner, Rostock (DE)

Correspondence Address: Raymond A Miller, c/o Pepper Hamilton LLP, 50th Floor, 500 Grant Street, Pittsburgh, PA, 15219-2502, US

(21) Appl. No.: 10/166,449

(22) Filed: Jun. 10, 2002

Related U.S. Application Data
(60) Provisional application No. 60/296,959, filed on Jun. 8, 2001.

(51) Int. Cl. G05B 15/00

(52) U.S. Cl. 700/1

(57) ABSTRACT

This invention relates to biocompatible and biodegradable polymers which are able to bind diagnostic and therapeutic radioisotopes, and the therapeutic use of the same as well as the synthesis of such polymers. It further relates to the preparation of functional implants from these materials, including nanospheres, microspheres, liposomes, micelles, coatings, films, fibers, and foils.

### CROSS REFERENCE TO RELATED APPLICATIONS

This application claims the benefit of U.S. Provisional Application No. 60/296,959 filed Jun. 8, 2001.

### BACKGROUND OF THE INVENTION

Unsealed radioactive sources were first used in cancer therapy soon after the Curies purified radium in 1898. However, therapeutic radiopharmaceuticals today are used only in a few, cancer-related malignancies such as hyperthyroidism (¹³¹I), pain palliation in bone cancer (⁸⁹Sr, ¹⁸⁶Re-phosphonates), radioimmunotherapy for lymphoma (¹⁸⁶Re-, ⁹⁰Y-labeled antibodies), radiotherapy for somatostatin-receptor positive neuroendocrine tumors and metastases (⁹⁰Y-, ¹³¹I-labeled octreotide), local liver tumor therapy (⁹⁰Y-glass or resin-microspheres) and brain cysts (³²P-chromate).

Tumors, stenoses of biological conduits, and other proliferative lesions can be effectively treated with radiation, which is known to inhibit cellular proliferation. The mechanism by which radiation prevents such proliferative cellular response is by preventing replication and migration of cells and by inducing programmed cell death (apoptosis).

Cells are variably susceptible to radiation, dependent on the types of cells and their proliferative status. Rapidly proliferating cells are generally more radiation-sensitive, whereas quiescent cells are more radiation-tolerant. High doses of radiation can kill all functions of even quiescent cells. Lower levels can merely lead to division delays, but the desirable effect of reproductive death is still obtained. In this case, the cell remains structurally intact but has lost its ability to proliferate, or divide indefinitely. It appears that low level radiation produces this desirable effect without causing tissue destruction or wasting (atrophy).

Traditional high-dose external beam radiation treatment, and prolonged low-dose radiation treatment (brachytherapy), are well-established therapies for the treatment of cancer, a malignant form of cellular proliferation. In particular, attention is currently being directed to the practical aspects of the use of brachytherapy. These aspects are, of course, particularly significant when radioactivity is involved. A disease site in a patient may be exposed to radiation from an external beam, either as a stand-alone procedure or in conjunction with an operative procedure. Alternatively, the radioactivity may be incorporated into an implantable device.

A pharmaceutical that contains a radionuclide with an appropriate treatment range can produce tumor doses of up to several hundred Grays (=Gy) after local application. These very high doses can be attained with minimal normal tissue toxicity, since radiation has a treatment range that depends on its mode of decay (alpha-, beta-, gamma-, or internal decay). The most commonly used beta-emitter for therapy, ⁹⁰Y, thus is able to sterilize up to 11 mm in tissue, but never more. Smaller lesions can and should be treated with a different radioisotope of a smaller treatment range, e.g. ¹⁸⁶Re or ¹⁶⁵Dy. In addition, radioactive pharmaceuticals are even effective in tumors that develop high tumor pressure, diffusion barriers or resistance, because radiation—unlike chemotherapeutic drugs—can also kill cells via “cross-fire” even when they are not in direct contact with all the tumor cells.

One reason that radiopharmaceuticals are not used more in tumor therapy is the lack of systems which could be used in many different malignancies, the large logistical demands when ordering, transporting and using radioisotopes with relatively short half-lives, and the generally large regulatory requirements when dealing with radioisotopes (radiation safety).

PCT Publication No. WO 01/54764 (claiming priority to U.S. Ser. No. 60/178,083 and U.S. Ser. No. 09/769,164) which is hereby incorporated in its entirety herein by reference thereto describes a bioabsorbable brachytherapy device which includes a tubular housing with sealed ends and an enclosed radioactive material useful in brachytherapy.

Effective in vitro and in vivo results involving targeting of magnetic radioactive 90Y-microspheres to tumor cells by an externally applied magnetic field were described in Hafeli et al, Nucl. Med. Bio. Vol 22 No. 2 pp 147-155 (1995), which is hereby incorporated in its entirety by reference thereto.

### SUMMARY OF THE INVENTION

The present invention provides a novel polymeric system able to specifically bind diagnostic and therapeutic radioisotopes.

More particularly, the present invention relates to biocompatible compounds and therapeutic compositions for fixation of radionuclides represented by the chemical formula (M) (L)j(Ch)k+1, wherein j is the number 0, 1 or 2; k is the number 0, 1 or 2; M is a polymeric matrix; Ch is a chelator; and L is a linker possessing covalent bonds to said polymeric matrix and said chelator, preferably derived from an at least bifunctional compound. Preferably, M is selected from the group consisting of polyesters, polyamides, polyurethanes, polyethers, polyacetals, polysiloxanes, polysilicic acid or copolymers, blends and composites thereof. More preferably, M is selected from the group consisting of polyesters of hydroxy carboxylic acids containing 2 to 6 carbon atoms and copolymers and composites thereof; polyglycolide and polylactide and copolymers and composites thereof; polysiloxanes and polysilicic acid and copolymers and composites thereof. Ch is preferably selected from the group consisting of macrocyclic compounds or their open-chain analogs, having a XC2Y or XC3Y geometry wherein X and Y are oxygen, nitrogen or sulfur. More preferably, Ch is selected from the group consisting of acyclic or cyclic amino, mercapto and hydroxy acid derivatives having a high binding capacity to radionuclides. The biocompatible compounds and therapeutic compostions of the present invention may also have different chelators present therein.

The present invention also relates to biocompatible polymers and therapeutic compositions that are formed in the shape of material selected from solid particles, liposomes or micelles, other bodies in predefined shape, threads, fibers or meshes, foils or films by themselves, as well as in combination or as part of metallic, ceramic, plastic and biopolymer implants. In the preferred embodiment, the biocompatible polymers and therapeutic compositions are formed in the shape of microspheres or nanoparticles. In another embodiment of the present invention, a chemotherapeutic drug is encapsulated in the microspheres.

The present invention also provides a new brachytherapy system that employs radioactivity very close to the target area, based on polymer-bound chelators that will effectively treat small amounts of residual solid tumor in different sites. More particularly, the present invention provides a method of treating a tumor, comprising implanting in or around the tumor the biocompatible compound or thereapeutic composition described above and a therapeutically effective amount of a radionuclide. The proposed system consists of a polymer-bound chelator in the form of nanospheres, microspheres, magnetic microspheres, polymeric sheets, or gels that solidify on contact with tissue. It can be labeled at the hospital or radiopharmacy on the day of therapy with the calculated amount of radioisotope and then inserted at the tumor site. The radioisotopes would stay at the application site and irradiate the tumor cells from there. After complete decay, the microspheres would biodegrade into physiological metabolites and completely disappear.

Polymeric polyesters such as the polylactide examples below are well suited for use as radiopharmaceuticals. They are biocompatible, non-toxic, and biodegrade in a controlled manner, according to their molecular weight and structure. They can be formed into nanospheres, microspheres, polymeric sheets, or even a gel that solidifies on contact with tissue. Chelating polymers have very similar physical properties to the unaltered polymer. In addition, they are capable of binding diagnostic and therapeutic radioisotopes in a fast and reliable fashion with high binding stability. The polymers and their respective molecular weights are chosen such that their biodegradation behavior matches the half-life of the radioisotope. For example, if ¹⁸⁸Re, with a half-life of 17 hours, is used as the radioisotope, then the microspheres must not start to biodegrade until at least 4 half-lives (about 3 days) have passed. At that time, about 94% of the radiation has been delivered and the degradation, which may result in a release of the radioactivity, will have only minor effects on the treatment outcome and will not lead to undue toxicity.

Polymeric microspheres have an additional benefit in that they can be radiolabeled even after being produced to enclose chemotherapeutic drugs and other substances. Radiosensitizer-releasing microspheres can thus be combined with therapeutic radioisotopes, further enhancing the treatment effect. A physical enhancement effect is possible by making the final radiopharmaceutical magnetic. For example, magnetic microspheres can be prepared by adding up to 50 weight % magnetite to the polymer solution during microsphere formation. Such magnetic microspheres can be targeted to specific organs or tumors with very high efficiency (for a review, see Schütt W. et al., Hybridoma 16, 109-117 (1997).

Immediate applications for the polymer-chelators bound to ⁹⁹Tc or ¹¹¹ In are diagnostic imaging. Also immediately useful would be to use them as carriers of the therapeutic radioisotopes ¹⁸⁶Re, ¹⁸⁸Re, ⁹⁰Y, and other radioisotopes to treat cancer. Chemoembolization, drug targeting, local application of radioactive wafers and pieces of material, as well as the use of radioactive biodegradable sutures for prostate implants “without the implant” are also very enticing possibilities.

Tumors that would particularly benefit by the present invention include partially resected or non-resectable but accessible tumors such as pancreatic carcinomas; recurrent deeply invasive tumors such as colorectal carcinomas and sarcomas in sites that do not allow complete surgical excision; partially resected tumors near important organs, nerves or major blood vessels; all tumors with a “positive surgical margin” after maximal surgery; and brain tumors that recur with high probability in the same location, such as glioblastomas in more than 50% of the cases. These cases lend themselves to the use of polymeric radiolabeled sheets because the amount of radioactivity can easily be prescribed as “activity per cm²,” and the radioactive polymeric sheet can be cut to size at the time of insertion.

The present invention may replace many brachytherapy applications currently based on ¹²⁵I seeds, ³²P colloids or other radioisotopes. The use of the rhenium isotopes is radiobiologically favorable due to relatively high initial dose rates of 50 or more cGy/h and little expected toxicity (no bone uptake). The labeling can be done very cost effectively and to predetermined, dosimetrically ideal amounts on a kit basis using radioactive perrhenate from a ¹⁸⁸W/¹⁸⁸Re-generator (for a description see Knapp FF et al., Anticancer Research 17, 1783-1795 (1997)).

The procedures could generally be repeated, unlike external radiotherapy, and the application of radiolabeled biodegradable polymers in microsphere, suture or other form may be possible in most of the cases on an outpatient protocol basis.

### DETAILED DESCRIPTION OF THE INVENTION

The current invention relates to biocompatible polymers, which can bind diagnostic and therapeutic radioisotopes through specific chelators.

The general formula is (M)−(L)ⱼ−(Ch)ₖ₊₁. In this general formula, (M) is the polymer matrix made from natural or synthetic materials, such as polyesters, polyamide, polyurethane, polyether, polyacetale, polysiloxanes and polysilicates, and derivatives thereof. It has been shown that the use of copolymers or composites of the listed polymers is sometimes beneficial. Especially useful for the described invention from the class of biodegradable polyesters are derivatives of hydroxycarboxylic acids, such as polylactide, polyglycolide, polycaprolactone, but also their co-polymers such as poly (lactide-co-glycolide) and polyesters with monomer units of C₄-, C₅- and C₆. Materials which are not biodegradable but highly inert and biocompatible are polysilicates, silicium dioxide, organically modified derivatives thereof and also polysiloxanes.

In the general formula, (Ch) is a chelator derived of a macrocyclic compound or its open ended analog. These chelators contain characteristic elements, specifically XC₂Y— and XC₃Y-geometries. X and Y are identical or different elements from the group of electron donors, mainly oxygen, nitrogen and sulfur. The structural elements of the chelators can be derived from ethanolamine-, ethanoldiamine-, and cysteamine-sequences or their homologues, but also from- or -amine, -hydroxy- and -mercapto-carboxy acids. The structural elements can combine semicyclic or cyclic units. Examples for such structures are chain-like or cyclic ethylenediamine derivatives such as diethylene triamine pentaacetic acid (=DTPA) or 1,4,7,10-tetraazacyclododecane-tetraacetic acid (=DOTA) but also di- or tripeptides and their derivatives. One such compound is the chelator N-mercaptoacetyl-glycylglycylglycine (=MAG₃). Chelators have a large binding capacity for specific isotopes. Specifically, DTPA or DOTA bind yttrium-90 or dysprosium-165 with high labeling efficiency and good stability, and MAG₃ is an excellent chelator for technetium-99 m or rhenium-188.

In the general formula, (L) is the chemical structure covalently linking the polymeric matrix and the chelator. Such linkers are normally bifunctional and stem from the class of diamine, diole, dithiole, dicarboxylic acid, diisocyanate or diisothiocyanate. Very often they also contain two structurally different functional groups with distinct chemical reactivities.

In some cases it is useful to combine the polymer matrix (M) with different types of linkers (L) or chelators (Ch), respectively.

The biocompatible materials with chemical groups for the stable binding of radionuclides can additionally contain magnetic or magnetizable materials. Examples are metallic iron, cobalt or nickel, alloys thereof, but also the oxides- or -iron (III) oxides or magnetite which can be doped in a proportionate way by other two- or three-valent metal ions. These metal ions include cobalt, samarium, neodymium, nickel, chromium, and gadolinium.

The radioisotope chelating biodegradable matrix can take many different forms and shapes, including pre-organized and particulate structures such as micelles, liposomes, nanoparticles and nanocapsules sized from about 10 nm to about 1000 nm, and microparticles and microcapsules sized from about 0.5 μm to about 1 mm. Nano- and microparticles can be of spherical or irregular shape, filled, hollow, porous or solid, and can consist of one or several materials, layers and coatings. The chelating matrix also includes other bodies in predefined shape, threads, fibers or meshes, foils or films by themselves, in combination or as part of metallic, ceramic, plastic or biopolymer implants. The application of these chelating implants can be done by itself, in combination or as part of implants made from metal, ceramic, plastic and biopolymers.

Biocompatible chelating materials containing magnetic components should be utilized preferentially in the form of nano- and microspheres.

Nanoparticles and microparticles with or without magnetic component can include additional functionalities and properties. Specifically, they can contain drugs such as chemotherapeutica and other effective substances encapsulated into the biodegradable chelating matrix substance. The choice of the chemotherapeutic drug is determined by therapeutic criteria. Since the application of these chelating polymers is done in radioactive form, it is preferred that the choice of chemotherapeutic drug also includes the criteria of radiosensitizing properties of the drug. Radiosensitizing drugs such as 5-fluorouracil (5-FU) or its precursor 5-fluorocytosine, taxol, etanidazole, tirapazamine, nimorazole, cisplatin, doxorubicin, 3-aminobenzamide, novobiocin, flavone-8-acetic acid are preferred and allow to increase the treatment effect with lower toxicity and less side effects.

The present invention permits biodegradable chelating matrices to be bound with exact, predetermined amounts of radioactive isotopes, useful both for diagnostic and therapeutic applications. The shape of invention can be varied extensively such that body areas of different size and form can be treated. Exact positioning is possible and allows for very defined dosimetry and radioisotope dependent treatment depth. Medical applications of such radioactively chelated matrices in the form of microspheres are local tumor injection, treatment of synovial inflammation in arthritic joints (radiosynovectomy) and also embolization of liver tumors with larger microspheres (radioembolization). The radiolabeled materials of the invention can also be drawn into threads which can be used directly for brachytherapy. Such radioactive threads could potentially replace iodine-125 or palladium-103 seeds for the treatment of prostate cancer. Left-over cancer cells from incompletely resected tumors can be treated with a booster dose of radiation from locally placed chelating wafers or foils. A similar approach is the use of a solution of the chelated biodegradable polymer in DMSO. Upon contact with body fluids, the polymer precipitates in situ and adheres to the surface of the target area, irradiating the left-over tumor cells.

The magnetic chelating materials additionally allow their positioning as well as magnetic targeting through external magnetic fields. Magnetic radioactive microspheres injected in a patient can thus be concentrated in a tumor area with a magnet attached above or in it. Strong enough magnetic fields lead to extravasation of the microspheres, a process which essentially pulls the microspheres across the capillary wall. The magnet can be removed after 10 to 15 minutes, and it has been shown that the magnetic microspheres stay in place and locally irradiate the tumor area. Tumors that can be treated with this method using the radiolabeled materials of the invention include not only well vascularized cancers such as liver, kidney, and pancreas, but also lung and brain tumors.

Any type of implantable tissue or device may be prepared in accordance with this invention and the method may be practiced to treat any type of condition that has been found to respond to the localized irradiation of tissue.

The present invention will be further understood by reference to the following non-limiting examples illustrating the preparation and radiolabeling of the present invention. The present invention is in not restricted to these examples.

### EXAMPLES

### Example 1

DOTA Modified Poly (Lactic Acid) Particles (Diameter: 3 μm), Method 1

To 20 g (11 mmol) of poly (lactic acid) 2000 (Boehringer Ingelheim, Germany) dissolved in dichloromethane (100 ml) are added 1.1 g (11 mmol) of maleic acid anhydride. Under continuous stirring 1.4 g (5 mmol) of 2-fluoro-1-methyl-pyridinium-toluene-4-sulfonate are added and the reaction mixture is stirred over night at room temperature. Then the solution is concentrated to 20 ml in vacuo at 40° C., the product precipitated by the addition of methanol (100 ml), filtrated off or separated by centrifugation, washed two times with methanol (20 ml at a time) and dried in vacuo (maleic acid esterified poly (lactic acid), yield: 15.5 g=74%).

To 10 g (5 mmol) of maleic acid esterified poly (lactic acid), 1.1 g (10 mmol) of 1,6-diaminohexane and 1 g (10 mmol) of triethylamine in chloroform (70 ml) are added 2 g (10 mmol) of N,N′-dicyclohexylcarbodiimide at 50° C. and the reaction mixture is stirred for 1 h. After the complete removal of the solvent in vacuo at 40° C. isopropanol (60 ml) is added, the resulting precipitate is separated by centrifugation, washed two times with isopropanol (10 ml at a time) and dried in vacuo (amino modified poly(lactic acid), yield: 7.86 g=78%).

1.2 g (3 mmol) of 1,4,7,10-tetraazacyclododecane-N,N′,N″,N′″-tetraacetic acid (DOTA) and 1.8 g (15 mmol) of 4-(dimethylamino)-pyridine (DMAP) are dissolved in acetonitrile (180 ml) and water (12 ml). The reaction mixture is heated to 50° C. and 0.6 g (3 mmol) of N-(3-dimethylaminopropyl)-N′-ethylcarbodiimide hydrochloride (EDC) in acetonitrile (60 ml) are added under stirring. The heating is removed after 10 min and then 5 g (3 mmol) of amino modified poly(lactic acid) in acetonitrile (180 ml) are added under continuous stirring. After 16 h stirring at room temperature the solution is brought to pH 5-6 by the addition of 0.1 M hydrochloric acid and the solvent is completely removed in vacuo at 40° C. The residue is washed with water (60 ml), separated by centrifugation, washed two times with water (180 ml at a time) and one time with isopropanol (180 ml) and dried in vacuo (DOTA modified poly(lactic acid), yield: 5.7 g=79%).

1 g of DOTA modified poly(lactic acid) is dissolved in chloroform (4 ml). This solution is added with a syringe to 320 ml of a dispergated (Turrax T25 with dispergator, IKA, Germany, 8000 rpm) solution of 1% of polyvinylalcohol in water. Dispergating is continued for 45 min and this is followed by centrifugation at 1000 g for 10 min. The particles are washed three times with water (40 ml at a time) and stored at 4° C.

### Example 2

DTPA Modified Poly(Lactic Acid) Particles (Diameter: 3 μm), Method 1

Amino modified poly(lactic acid) was prepared according to example 1. 1.2 g (3 mmol) of diethylenetriaminepentaacetic acid (DTPA) and 2.2 g (18 mmol) of 4-(dimethylamino)-pyridine (DMAP) are dissolved in acetonitrile (800 ml) and water (80 ml). The reaction mixture is heated to 50° C. and 0.6 g (3 mmol) of N-(3-dimethylaminopropyl)-N′-ethylcarbodiimide hydrochloride (EDC) are added under stirring. The heating is removed after 10 min and then 5 g (3 mmol) of amino modified poly(lactic acid) in acetonitrile (320 ml) and water (40 ml) are added under continuous stirring. After 16 h stirring at room temperature the solution is brought to pH 5-6 by the addition of 0.1 M hydrochloric acid and the solvent is completely removed in vacuo at 40° C. The residue is washed with water (400 ml), separated by centrifugation, washed two times with water (400 ml at a time) and one time with isopropanol (400 ml) and dried in vacuo (DTPA modified poly(lactic acid), yield: 3.8 g=53%).

1 g of DTPA modified poly(lactic acid) is dissolved in chloroform (4 ml). This solution is added with a syringe to 320 ml of a dispergated (Turrax T25 with dispergator, IKA, Germany, 8000 rpm) solution of 1% of polyvinylalcohol in water. Dispergating is continued for 45 min and this is followed by centrifugation at 1000 g for 10 min. The particles are washed three times with water (40 ml at a time) and stored at 4° C.

### Example 3

MAG₃ Modified Poly(Lactic Acid) Particles (Diameter: 3 μm)

Amino modified poly(lactic acid) was prepared according to example 1.

0.8 g (3 mmol) of mercaptoacetylglycylglycylglycine (MAG₃) are dissolved in acetonitrile (550 ml) and water (110 ml) and 0.4 g (3 mmol) of 4-(dimethylamino)-pyridine (DMAP) are added. The reaction mixture is heated to 50° C. and 0.6 g (3 mmol) of N-(3-dimethylaminopropyl)-N′-ethylcarbodiimide hydrochloride (EDC) in acetonitrile (110 ml) are added under stirring. The heating is removed after 10 min and then 5 g (3 mmol) of amino modified poly(lactic acid) in acetonitrile (320 ml) and water (40 ml) are added under continuous stirring. After 16 h stirring at room temperature the solution is brought to pH 5-6 by the addition of 0.1 M hydrochloric acid and the solvent is completely removed in vacuo at 40° C. The residue is washed with water (400 ml), separated by centrifugation, washed two times with water (400 ml at a time) and one time with isopropanol (400 ml) and dried in vacuo (MAG₃ modified poly(lactic acid), yield: 6.1 g=90%).

1 g of MAG₃ modified poly(lactic acid) is dissolved in chloroform (4 ml). This solution is added with a syringe to 320 ml of a dispergated (Turrax T25 with dispergator, IKA, Germany, 8000 rpm) solution of 1% of polyvinylalcohol in water. Dispergating is continued for 45 min and this is followed by centrifugation at 1000 g for 10 min. The particles are washed three times with water (40 ml at a time) and stored at 4° C.

### Example 4

DOTA Modified Magnetic Poly(Lactic Acid) Particles (Diameter: 3 μm), Method 1

DOTA modified poly(lactic acid) was prepared according to example 1. 1g of DOTA modified poly(lactic acid) is dissolved in chloroform (3 ml). Then chloroform (3 ml) is added to 0.4 g magnetite (d=30-300 nm), the suspension is sonicated for 15 min and combined with the solution of the DOTA modified poly(lactic acid). The resulting suspension is added with a syringe to 320 ml of a dispergated (Turrax T25 with dispergator, IKA, Germany, 8000 rpm) solution of 1% of polyvinylalcohol in water. Dispergating is continued for 45 min and the particles are washed three times magnetically with water (40 ml at a time) and stored at 4° C.

### Example 5

DTPA Modified Magnetic Poly(Lactic Acid) Particles (diameter: 3 μm), Method 1

DTPA modified poly(lactic acid) was prepared according to example 2. 1 g of DTPA modified poly(lactic acid) is dissolved in chloroform (3 ml). Then chloroform (3 ml) is added to 0.4 g magnetite (d=30-300 nm), the suspension is sonicated for 15 min and combined with the solution of the DTPA modified poly(lactic acid). The resulting suspension is added with a syringe to 320 ml of a dispergated (Turrax T25 with dispergator, IKA, Germany, 8000 rpm) solution of 1% of polyvinylalcohol in water. Dispergating is continued for 45 min and the particles are washed three times magnetically with water (40 ml) at a time and stored at 4° C.

### Example 6

DOTA Modified Poly(Lactic Acid) Particles (Diameter: 3 μm), Method 2

1 g of poly(lactic acid) 2000 (Boehringer Ingelheim, Germany) is dissolved in chloroform (4 ml). This solution is added with a syringe to 320 ml of a dispergated (Turrax T25 with dispergator, IKA, Germany, 8000 rpm) solution of 1% of polyvinylalcohol in water. Dispergating is continued for 45 min and this is followed by centrifugation at 1000 g for 10 min. The particles are washed three times with water (40 ml at a time) and stored at 4° C.

To 10 ml of a poly(lactic acid) particle suspension with a concentration of 50 mg/ml are added 20 mg of sodium n-dodecyl sulphate and the suspension is rotated (70 rpm) at room temperature for 1 h. Then 0.58 g (7 mmol) of methacrylic acid, 20 mg (0.1 mmol) of ethylene glycol dimethacrylate and 0.11 g (0.4 mmol) of potassium peroxydisulphate are added and the suspension is rotated (70 rpm) at 65° C. for 16 h followed by rotation at room temperature and 100 mbar for 1 h. The carboxylic acid modified particles are washed three times with water (20 ml at a time) by centrifugation (1000 g and 10 min) and stored at 4° C.

34 mg (0.18 mmol) of N-(3-dimethylaminopropyl)-N′-ethylcarbodiimide hydrochloride (EDC) and 18 mg (0.17 mmol) of sodium carbonate are dissolved in water (1 ml) and added to 4 ml of a carboxylic acid modified poly(lactic acid) particle suspension with a concentration of 50 mg/ml. After addition of 22 mg (0.19 mmol) of N-hydroxysuccinimide the particle suspension is shaken at room temperature for 30 min. 20 mg (0.19 mmol) of diethylenetriamine are dissolved in water (1 ml) and added to the particle suspension followed by shaking for 2 h. The amino modified particles are washed three times with water (20 ml at a time) by centrifugation (1000 g and 10 min) and stored at 4° C.

10 mg (2.5 10⁻⁵ mol) of 1,4,7,10-tetraazacyclododecane-N,N′,N″,N′″-tetraacetic acid (DOTA) are dissolved in 1 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 2 ml of an amino modified poly(lactic acid) particle suspension with a concentration of 50 mg/ml. The suspension is shaken at room temperature for 16 h and the DOTA modified poly(lactic acid) particles are washed three times with water (10 ml at a time) by centrifugation (1000 g and 10 min) and stored at 4° C.

### Example 7

DTPA Modified Poly(Lactic Acid) Particles (Diameter: 3 μm), Method 2

Amino modified poly(lactic acid) particles were prepared according to example 6. 10 mg (2.5 10⁻⁵ mol) of diethylenetriaminepentaacetic acid (DTPA) are dissolved in 1 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 2 ml of an amino modified poly(lactic acid) particle suspension with a concentration of 50 mg/ml. The suspension is shaken at room temperature for 16 h and the DTPA modified poly(lactic acid) particles are washed three times with water (10 ml at a time) by centrifugation (1000 g and 10 min) and stored at 4° C.

### Example 8

DOTA Modified Magnetic Poly(Lactic Acid) Particles (Diameter: 3 μm), Method 2

1 g of poly(lactic acid) 2000 (Boehringer Ingelheim, Germany) is dissolved in chloroform (3 ml). Then chloroform (3 ml) is added to 0.4 g magnetite (d=30-300 nm), the suspension is sonicated for 15 min and combined with the solution of the poly(lactic acid) 2000. The resulting suspension is added with a syringe to 320 ml of a dispergated (Turrax T25 with dispergator, IKA, Germany, 8000 rpm) solution of 1% of polyvinylalcohol in water. Dispergating is continued for 45 min and the particles are washed three times magnetically with water (40 ml at a time) and stored at 4° C.

To 10 ml of a magnetic poly(lactic acid) particle suspension with a concentration of 50 mg/ml are added 20 mg of sodium n-dodecyl sulphate and the suspension is rotated (70 rpm) at room temperature for 1 h. Then 0.58 g (7 mmol) of methacrylic acid, 20 mg (0.1 mmol) of ethylene glycol dimethacrylate and 0.11 g (0.4 mmol) of potassium peroxydisulphate are added and the suspension is rotated (70 rpm) at 65° C. for 16 h followed by rotation at room temperature and 100 mbar for 1 h. The carboxylic acid modified magnetic particles are washed three times magnetically with water (20 ml at a time) and stored at 4° C.

34 mg (0.18 mmol) of N-(3-dimethylaminopropyl)-N′-ethylcarbodiimide hydrochloride (EDC) and 18 mg (0.17 mmol) of sodium carbonate are dissolved in water (1 ml) and added to 4 ml of a carboxylic acid modified magnetic poly(lactic acid) particle suspension with a concentration of 50 mg/ml. After addition of 22 mg (0.19 mmol) of N-hydroxysuccinimide the particle suspension is shaken at room temperature for 30 min. 20 mg (0.19 mmol) of diethylenetriamine are dissolved in water (1 ml) and added to the particle suspension followed by shaking for 2 h. The amino modified magnetic particles are washed three times magnetically with water (20 ml at a time) and stored at 4° C.

10 mg (2.5 10⁻⁵ mol) of 1,4,7,10-tetraazacyclododecane-N,N′,N″,N′″-tetraacetic acid (DOTA) are dissolved in 1 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 2 ml of an amino modified magnetic poly(lactic acid) particle suspension with a concentration of 50 mg/ml. The suspension is shaken at room temperature for 16 h and the DOTA modified magnetic poly(lactic acid) particles are washed three times magnetically with water (10 ml at a time) and stored at 4° C.

### Example 9

DTPA Modified Magnetic Poly(Lactic Acid) Particles (Diameter: 3 μm), Method 2

Amino modified magnetic poly(lactic acid) particles were prepared according to example 8. 10 mg (2.5 10⁻⁵ mol) of diethylenetriaminepentaacetic acid (DTPA) are dissolved in 1 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 2 ml of an amino modified magnetic poly(lactic acid) particle suspension with a concentration of 50 mg/ml. The suspension is shaken at room temperature for 16 h and the DTPA modified magnetic poly(lactic acid) particles are washed three times magnetically with water (10 ml at a time) and stored at 4° C.

### Example 10

DOTA Modified Silica Particles (Diameter: 5 μm)

2 g of silica particles (LiChrospher Si 60, 5 μm, Merck, Germany) are dried at 200° C. in vacuo for 2 h and then cooled down to room temperature under continuous rotating (100 rpm). The particles are resuspended under atmospheric pressure in tetrahydrofuran (50 ml), 40 μl of diphenyldichlorosilane are added and the suspension is rotated (100 rpm) at room temperature for 1 h. After the addition of 2 ml of (3-aminopropyl)triethoxysilane rotation is continued at 50° C. for 20 h. The amino modified silica particles are washed two times with tetrahydrofuran (20 ml at a time), two times with diethylether (20 ml at a time) and one time with ethanol (20 ml) by centrifugation (1000 g and 10 min) and dried in vacuo.

10 mg (2.5 10⁻⁵ mol) of 1,4,7,10-tetraazacyclododecane-N,N′,N″,N′″-tetraacetic acid (DOTA) are dissolved in 10 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 0.5 g of amino modified silica particles. The suspension is shaken at room temperature for 16 h and the DOTA modified silica particles are washed three times with water (10 ml at a time) by centrifugation (1000 g and 10 min).

### Example 11

DTPA Modified Silica Particles (Diameter: 5 μm)

Amino modified magnetic silica particles were prepared according to example 10. 10 mg (2.5 10⁻⁵ mol) of diethylenetriaminepentaacetic acid (DTPA) are dissolved in 10 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 0.5 g of amino modified silica particles. The suspension is shaken at room temperature for 16 h and the DTPA modified silica particles are washed three times with water (10 ml at a time) by centrifugation (1000 g and 10 min).

### Example 12

MAG₃ Modified Silica Particles (Diameter: 0.5 μm)

120.8 ml of ethanol, 120.2 ml of water and 30.4 g of ammonium hydroxide (28-30%) are mixed in a round-bottom flask. After the addition of 52.3 g of tetraethoxysilane the reaction mixture is rotated (70 rpm) at 40° C. for 1 h. Then the particle suspension is cooled down to room temperature under continuous rotating. The silica particles are washed one time with ethanol (200 ml), one time with 200 ml of a mixture of water/ethanol (1/1, v/v) and three times with water (200 ml at a time) by centrifugation (1000 g and 10 min).

2 g of silica particles are dried at 200° C. in vacuo for 2 h and then cooled down to room temperature under continuous rotating. The particles are resuspended under atmospheric pressure in tetrahydrofuran (50 ml), 40 μl of diphenyldichlorosilane are added and the suspension is rotated (100 rpm) at room temperature for 1 h. After the addition of 2 ml of (3-aminopropyl)triethoxysilane rotation is continued at 50° C. for 20 h. The amino modified silica particles are washed two times with tetrahydrofuran (20 ml at a time), two times with diethylether (20 ml at a time) and one time with ethanol (20 ml) by centrifugation (1000 g and 10 min) and dried in vacuo.

10 mg (3.8 10⁻⁵ mol) of mercaptoacetylglycylglycylglycine (MAG₃) are dissolved in 10 ml of a 0.1 M 2-(4-morpholino)ethanesulphonic acid hydrate/sodium carbonate buffer (pH 6.3), 7.3 mg (3.8 10⁻⁵ mol) of N-(3-dimethylaminopropyl)-N′-ethylcarbodiimide hydrochloride (EDC) are added, the solution is incubated for 10 min at 50° C. and then added to 0.5 g of amino modified silica particles. The suspension is shaken at room temperature for 16 h and the MAG₃ modified silica particles are washed three times with water (10 ml at a time) by centrifugation (1000 g and 10 min).

### Example 13

DOTA Modified Magnetic Silica Particles (Diameter: 6 μm)

2 g of silica particles (LiChrospher Si 60, 5 μm, Merck, Germany) are suspended in 50 ml of a magnetite suspension with a concentration of 20 mg/ml (d=400 nm) and the solvent removed in vacuo under rotation (100 rpm). The residue is dried at 200° C. in vacuo for 2 h and then cooled down to room temperature under continuous rotating. The particles are resuspended under atmospheric pressure in tetrahydrofuran (50 ml), 40 μl of diphenyldichlorosilane are added and the suspension is rotated (100 rpm) at room temperature for 1 h. After the addition of 2 ml of (3-aminopropyl)triethoxysilane rotation is continued at 50° C. for 20 h. The amino modified silica particles are washed two times magnetically with tetrahydrofuran (20 ml at a time), two times with diethylether (20 ml at a time) and one time with ethanol (20 ml) and dried in vacuo.

10 mg (2.5 10⁻⁵ mol) of 1,4,7,10-tetraazacyclododecane-N,N′,N″,N′″-tetraacetic acid (DOTA) are dissolved in 10 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 0.5 g of amino modified magnetic silica particles. The suspension is shaken at room temperature for 16 h and the DOTA modified silica particles are washed three times magnetically with water (10 ml at a time).

### Example 14

DTPA Modified Magnetic Silica Particles (Diameter: 6 μm)

Amino modified magnetic silica particles were prepared according to example 13. 10 mg (2.5 10⁻⁵ mol) of diethylenetriaminepentaacetic acid (DTPA) are dissolved in 10 ml of a 0.1 M 2-(4-morpholino)ethanesulphonic acid hydrate/sodium carbonate buffer (pH 6.3), 5 mg (2.5 10⁻⁵ mol) of N-(3-dimethylaminopropyl)-N′-ethylcarbodiimide hydrochloride (EDC) are added, the solution is incubated for 10 min at 50° C. and then added to 0.5 g of amino modified magnetic silica particles. The suspension is shaken at room temperature for 16 h and the DTPA modified silica particles are washed three times magnetically with water (10 ml at a time).

### Example 15

Labeling Efficiencies and Stabilities of Radiolabeled Microspheres

The following table summarizes the radiolabeling results and the stabilities measured after 24 hours in plasma (shaking water bath at 37° C.) after labeling with Re-188, Tc-99m, Y-90 and In-111 under conditions detailed in the table. The percentages in the “particle type” column give the amount of chelator-modified polymer that was used to make microspheres, with the rest of the microspheres consisting of unmodified poly(lactic acid).

| | Particle | | | Labeling | |
|---|---|---|---|---|---|
| | synthesis | | | efficiency | Stability in plasma |
| Particle type | example | Radionuclide | Labeling conditions | [%] | [%] |
| sicastar ® -MAG₃ | 12 | Re-188 | Gentisic acid/SnCl₂ pH 7, | 65 | 88 |
| | | | 99 C., 60 min | | |
| sicastar ® -MAG₃ | 12 | Tc-99m | 1 M Carbonate pH 10.5, | 23 | 100 |
| | | | SnCl₂, 70 C., 30 min | | |
| PLA-MAG₃ | 3 | Tc-99m | 1 M Carbonate pH 10.5, | 39 | 79 |
| | | | SnCl₂ , 70 C., 30 min | | |
| PLA-M-DOTA 50% | 4 | Y-90 | 0.5M Ammonium | 88 | 75 |
| | | | Acetate, pH 7, 50° C. | | |
| PLA-M-DOTA 100% | 4 | Y-90 | 0.5M Ammonium | 94 | 67 |
| | | | Acetate, pH 7, 50° C. | | |
| PLA-M-DTPA 50% | 5 | Y-90 | 0.5M Ammonium | 92 | 82 |
| | | | Acetate, pH 7, 50° C. | | |
| PLA-M-DTPA 100% | 5 | Y-90 | 0.5M Ammonium | 80 | 90 |
| | | | Acetate, pH 7, 50° C. | | |
| PLA-DTPA 20% | 2 | Y-90 | 0.5M Ammonium | 76 | 84 |
| | | | Acetate, pH 7, 50° C. | | |
| PLA-DTPA 50% | 2 | Y-90 | 0.5M Ammonium | 92 | 89 |
| | | | Acetate, pH 7, 50° C. | | |
| PLA-DTPA 100% | 2 | Y-90 | 0.5M Ammonium | 82 | 86 |
| | | | Acetate, pH 7, 50° C. | | |
| sicastar ® -DTPA | 14 | Y-90 | 0.5M Ammonium | 93 | 66 |
| | | | Acetate, pH 7, 50° C. | | |
| sicastar ® -DOTA | 13 | Y-90 | 0.5M Ammonium | 44 | 25 |
| | | | Acetate, pH 7, 50° C. | | |
| PLA-M-DOTA 100% | 4 | In-111 | 0.5M Ammonium | 98 | — |
| | | | Acetate, pH 7, 50° C. | | |
| PLA-M-DTPA 100% | 5 | In-111 | 0.5M Ammonium | 83 | — |
| | | | Acetate, pH 7, 50° C. | | |
| PLA-DTPA 100% | 2 | In-111 | 0.5M Ammonium | 82 | — |
| | | | Acetate, pH 7, 50° C. | | |
| sicastar ® -DTPA | 14 | In-111 | 0.5M Ammonium | 73 | — |
| | | | Acetate, pH 7, 50° C. | | |
| sicastar ® -DOTA | 13 | In-111 | 0.5M Ammonium | 95 | — |
| | | | Acetate, pH 7, 50° C. | | |

There have been described and illustrated herein several embodiments of a radioactive biocompatible compounds, and method of using the same to treat diseased states. While particular embodiments of the invention have been described, it is not intended that the invention be limited thereto, as it is intended that the invention be as broad in scope as the art will allow and that the specification be read likewise. For example, those skilled in the art will appreciate that certain features of one embodiment may be combined with features of another embodiment to provide yet additional embodiments. It will therefore be appreciated by those skilled in the art that yet other modifications could be made to the provided invention without deviating from its spirit and scope as so claimed and described.

What is claimed is:

1. A shaped material for delivery of a radionuclide comprised of a biocompatible compound for fixation of the radionuclide, said biocompatible compound represented by the chemical formula:
(M)(L)j(Ch)k+1
wherein j is the number 0, 1 or 2; k is the number 0, 1 or 2; M is a polymeric matrix; Ch is a chelator; and L is a linker possessing covalent bonds to said polymeric matrix and said chelator; and a radionuclide chelated to the biocompatible compound.

2. The shaped material of claim 1 wherein M is selected from the group consisting of polyesters, polyamides, polyurethanes, polyethers, polyacetals, polysiloxanes, polysilicic acid or copolymers, blends and composites thereof, Ch is selected from the group consisting of macrocyclic compounds or their open-chain analogs, having a XC2Y or XC3Y geometry wherein X and Y are oxygen, nitrogen or sulfur; and L is derived from an at least bifunctional compound.

3. The shaped material of claims 2, further including a proportional amount of a magnetizable material.

4. The shaped material of claim 2, wherein Ch is selected from the group consisting of acyclic or cyclic amino, mercapto and hydroxy acid derivatives having a high binding capacity to radionuclides.

5. The shaped material of claim 2, wherein different types of chelators are present.

6. The shaped material of claim 2, wherein the biocompatible polymer is the shape of the material is selected from the group consisting of solid particles, liposomes or micelles, other bodies in predefined shape, threads, fibers or meshes, foils or films by themselves, in combination or as part of metallic, ceramic, plastic and biopolymer implants.

7. The shaped material of claim 1, wherein the shape of material is a nanoparticles.

8. A microspheric composition comprised of a compound shaped as a microsphere represented by the following chemical formula:
(M)(L)j(Ch)k+1
wherein j is the number 0, 1 or 2; k is the number 0, 1 or 2; M is a polymeric matrix; Ch is a chelator for chelating a radioisotope; and L is a linker possessing covalent bonds to said polymeric matrix and said chelator; said microsphere having a diameter ranging from about 0.0005 to about 0.05 mm.

9. The microspheric composition of claim 8, wherein M is selected from the group consisting of polyesters, polyamides, polyurethanes, polyethers, polyacetals, polysiloxanes, polysilicic acid or copolymers, blends and composites thereof; Ch is selected from the group consisting of macrocyclic compounds or their open-chain analogs, having a XC2Y or XC3Y geometry wherein X and Y are oxygen, nitrogen or sulfur; and L is derived from an at least bifunctional compound.

10. The microspheric composition of claim 9, wherein said composition proportionately contains a magnetizable material.

11. The microspheric composition of claim 9, wherein Ch is selected from the group consisting of acyclic or cyclic amino, mercapto or hydroxy acid derivatives having a high binding capacity to radionuclides.

12. The microspheric composition of claim 8, wherein the radioisotope is chelated to said polymeric matrix.

13. A method of treating a tumor, comprising implanting a biocompatible compound in or around the tumor, said biocompatible material including a therapeutically effective amount of a radionuclide chelated to said biocompatible compound.

14. The method of claim 13, wherein said biocompatible compound is represented by the chemical formula:
(M)(L)j(Ch)k+1
wherein j is the number 0, 1 or 2; k is the number 0, 1 or 2; M is a polymeric matrix; Ch is a chelator; and L is a linker possessing covalent bonds to said polymeric matrix and said chelator; and a radioisotope chelated to the biocompatible compound.

15. The method of claim 13, wherein M is selected from the group consisting of polyesters, polyamides, polyurethanes, polyethers, polyacetals, polysiloxanes, polysilicic acid or copolymers, blends and composites thereof; Ch is selected from the group consisting of macrocyclic compounds or their open-chain analogs, having a XC2Y or XC3Y geometry wherein X and Y are oxygen, nitrogen or sulfur; and L is derived from an at least bifunctional compound.

16. The method of claim 14, further including a proportional amount of a magnetizable material.

17. The method of claim 14, wherein Ch is selected from the group consisting of acyclic or cyclic amino, mercapto and hydroxy acid derivatives having a high binding capacity to radionuclides.

18. The method of claim 14, wherein said radioisotope is selected from the group consisting of ¹⁸⁸Re, ¹⁸⁶Re, ¹¹¹In, ¹³¹I, ⁸⁹Sr, ³²P, ⁹⁹Tc, and ⁹⁰Y.

19. The method of claim 14, wherein said radioisotope is selected from the group consisting of ¹⁸⁸Re, ⁹⁹Tc, and ⁹⁰Y.

20. The method of claim 16, wherein said biocompatible material is selectively positioned through external magnetic fields.
